(19) United States
(12) Patent Application Publication
(10) Pub. No.: US 2021/0039044 A1
(43) Pub. Date: Feb. 11, 2021

(54) Carbon Dioxide Sequestration

(71) Applicant: Saline Water Conversion Corporation, Al-Jubail (SA)

(72) Inventors: Ahmed Saleh Mohammed ALAMOUDI, Al-Jubail (SA); Mohammed Farooque AYUMANTAKATH, Al-Jubail (SA); Nikolay VOUTCHKOV, Winter Springs, FL (US); Seungwon IHM, Al-Khobar (SA)

(21) Appl. No.: 16/536,573

(22) Filed: Aug. 9, 2019

(51) Int. Cl. B01D 53/80; B01D 53/62

(52) U.S. Cl. CPC B01D 53/80; B01D 53/62; B01D 2251/404; B01D 2258/06; B01D 2251/606; B01D 2257/504; B01D 2251/604

(57) ABSTRACT

A system and method are provided for sequestering of greenhouse gas in conjunction with operation of a desalination facility or water or wastewater treatment plant from which water hardness and alkalinity has to be adjusted to meet water quality requirements. Carbon dioxide in solution with a source water stream, such as a high-divalent ion desalination unit discharge stream or a low calcium concentration permeate stream, chemically reacts with a calcium-based compound such that calcium bicarbonate by mixing with a solution containing the calcium-based compound or by direct contact with a solid form of the compound. Preferably the pH of the calcium bicarbonate-containing output stream is adjusted to maintain pH in a range providing a nearly 100% sequestered carbon dioxide soluble product. The soluble product may be discharged to a natural water body or used as drinking, irrigation or industrial process water, or in another process having a pH of 7.5-9.0.

### BACKGROUND OF THE INVENTION

The present invention is directed to a method and system for permanent carbon dioxide sequestration, in particular to an approach of sequestering carbon dioxide by conversion into calcium bicarbonate.

Gases that trap heat in the atmosphere are referred to greenhouse gases (GHG). Some greenhouse gases, such as carbon dioxide, are emitted to the atmosphere by natural processes and human activities. Other greenhouse gases, such as fluorinated gases, are created and emitted solely by human activities.

Carbon dioxide is one of the principal greenhouse gases that enter the atmosphere because of human activities. This greenhouse gas is typically generated by the burning of fossil fuels (e.g., oil, natural gas, and coal), solid waste, trees and wood products, and also as a result of other chemical reactions (e.g., manufacture of cement). Carbon dioxide is also removed from the atmosphere (also referred to as being “sequestered”) when it is absorbed by plants as part of the biological carbon cycle.

Changes in the atmospheric concentrations of greenhouse gases, such as carbon dioxide alter the balance of energy transfers between the atmosphere, space, land, and the oceans and ultimately result in global and local climate variability and permanent changes. Many elements of human society and the environment are sensitive to climate variability and change. Human health, agriculture, natural ecosystems, coastal areas, and heating and cooling requirements are examples of climate-sensitive systems. The extent of climate change effects, and whether these effects prove harmful or beneficial, will vary by region, over time, and with the ability of different societal and environmental systems to adapt to or cope with the change.

Rising average temperatures are already affecting the environment. Some observed changes include shrinking of glaciers, thawing of permafrost, later freezing and earlier break-up of ice on rivers and lakes, lengthening of growing seasons, shifts in plant and animal ranges and earlier flowering of trees.

Global temperatures are expected to continue to rise as human activities continue to add carbon dioxide and other greenhouse (i.e., heat-trapping) gases to the atmosphere. Most of the United States is expected to experience an increase in average temperature as a result of increase in greenhouse gas emissions.

To address the raising global greenhouse emissions challenge, in 2006 Californian legislation (AB 32, the Global Warming Solutions Act) aimed to reduce the greenhouse gas (GHG) emissions of the state to 1990 levels by year 2020. Similar legislation is currently under consideration by the U.S. Federal government, and is already in place in number of other countries worldwide such as Australia and the European Union countries.

According to a recent U.S. Environmental Protection Agency (EPA) GHG emission inventory, the primary greenhouse gas emitted by human activities in the United States in 2006 was CO₂, representing approximately 84.8 percent of total greenhouse gas emissions. Therefore, development of methods for low-cost sequestration of carbon dioxide into environmentally benign and stable products is of critical importance for abating anthropogenic GHG emissions.

This and other objectives are addressed by the present invention. In the invention, carbon dioxide is sequestered in the form of fully dissolved calcium bicarbonate solution in water or other water media with pH of 7.5 to 9.0. This is accomplished by injection, mixing and chemical reaction of carbon dioxide with a source water stream which contains high level of calcium and/or a source water stream which has low calcium content and which is exposed to contact and chemical reaction with calcium-reach compounds such as calcium hydroxide (lime); limestone (calcite); dolomite, and any other solid or water media with high content of calcium capable of producing calcium bicarbonate upon contact and chemical reaction with the carbon dioxide. Sources for materials for such reaction include, for example, water desalination process streams which generate high concentration discharge streams and/or solids generated from such discharge streams.

The term “source water” is employed in its conventional sense to refer a number of different types of aqueous fluids other than fresh water including brackish water, seawater, and brine (including man-made brines such as geothermal plant wastewaters, etc.), as well as other source waters having a salinity that is greater than that of freshwater. Brine is water saturated or nearly saturated with salt and has a salinity that is 50 parts per thousand (ppt) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. The saltwater source from which the saltwater feedwater is obtained may be a naturally occurring source, such as a sea, ocean, lake, swamp, estuary, lagoon, etc., or a man-made source.

In certain embodiments, the saltwater source is an ocean or sea and the saltwater source water is seawater. Source waters of interest are ones which contain calcium. Examples of such waters are those that include calcium in amounts ranging from 50 ppm to 20,000 ppm, such as 200 ppm to 5000 ppm and including 400 ppm to 1000 ppm.

The carbon dioxide sequestration is accomplished in engineered reactors designed to provide adequate contact time and/or uniform flow distribution and mixing for complete conversion of the gaseous carbon dioxide into permanently soluble calcium bicarbonate. The invention is based on carbon dioxide dissolved in water or other waters participating in chemical reactions with calcium rich solutions and/or compounds, such as calcite, dolomite and calcium hydroxide (lime), with the reactions forming calcium bicarbonate (Ca (HCO₃)₂). The calcium bicarbonate is permanently dissolved in the water, as long as the pH of the water is maintained in pH in a range of 7.5 to 9.0.

The water media with a pH of 7.5 to 9.0, in which calcium bicarbonate can be sequestered permanently, include but are not limited to: ocean water; brackish water; desalinated water; groundwater; surface water; municipal or industrial wastewater; desalination plant concentrate, permeate and distillate; cooling water from power generation plants; or other water or wastewater discharges to surface water bodies or groundwater aquifers with pH in a range of 7.5 to 9.0.

The dissolved calcium bicarbonate product from some embodiments of the present invention may be subsequently employed to increase the calcium hardness and bicarbonate alkalinity of soft water (for example, soft water in the form of desalination plant permeate and distillate) in order to protect downstream distribution piping and storage system materials from corrosion. In addition, the dissolved calcium bicarbonate product may be used to increase the pH of water and wastewater discharges to surface water bodies such as oceans, rivers, lakes, etc., in order to abate pH decrease in such water sources due to anthropogenic impacts such as acid rain, etc.

The present invention thus provides for cost effective and reliable sequestration of carbon dioxide from anthropologic origin into a permanently soluble form of calcium bicarbonate, which then can be stored practically indefinitely in the waters of surface water bodies such as the world's oceans, seas, rivers, etc. The present invention also enables reduction of the corrosivity of soft water streams, such as desalinated water.

Other objects, advantages and novel features of the present invention will become apparent from the following detailed description of the invention when considered in conjunction with the accompanying drawings.

### BRIEF DESCRIPTION OF THE DRAWINGS

FIG. 1 is a graphical illustration of the solubility of carbon dioxide in water solution.

FIG. 2 is a schematic illustration of a carbon dioxide sequestration process in accordance with an embodiment of the present invention.

FIG. 3 is a schematic illustration of a further embodiment of the present invention in a desalination plant application.

### DETAILED DESCRIPTION

Before embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

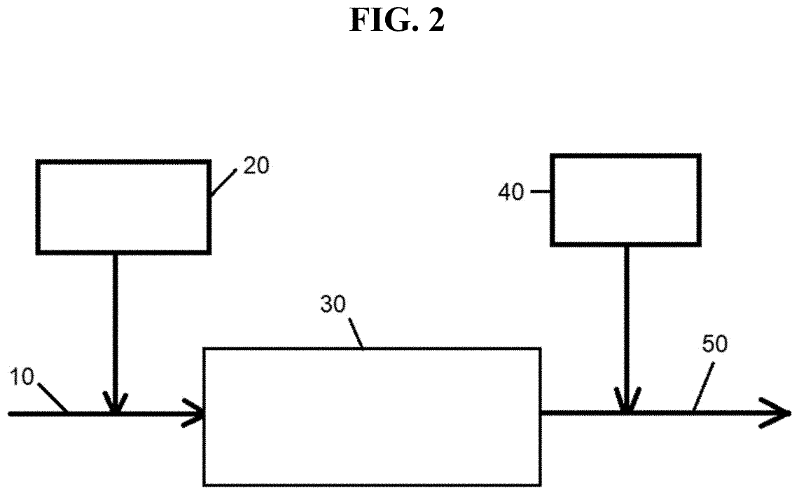

An embodiment of the present invention is schematically illustrated in FIG. 2. In this embodiment a source water stream 10 with high calcium content is provided. The calcium-rich source stream 10 from such a process receives carbon dioxide from a CO₂ gaseous stream source 20, such as a purified carbon dioxide generated as a waste product from industrial activities. The source stream 10 containing the injected CO₂ is input to an engineered reactor 30 that provides an environment to mix and chemically react the carbon dioxide with calcium hydroxide or calcium carbonate in order to form soluble calcium bicarbonate. For example, the permanent conversion and sequestration of gaseous or dissolved carbon dioxide into completely soluble calcium bicarbonate (Ca (HCO₃)₂) occurs when the carbon dioxide is exposed to calcium carbonate (CaCO₃) and forms completely soluble calcium bicarbonate according to the reaction:

CaCO₃+CO₂+H₂O→Ca(HCO₃)₂

The source of CO₂ that is contacted with the volume of water may be a liquid, solid (e.g., dry ice) or gaseous CO₂ source. In certain embodiments, the CO₂ source is a gaseous CO₂ source. The source of the gaseous CO₂ may vary widely, ranging from air, industrial waste streams, etc. The gaseous CO₂ is, in certain instances, a waste product from an industrial plant. The nature of the industrial plant may vary, where industrial plants of primary interest include power plants (e.g., the flue gases from an electrical power plant), chemical processing plants, and other industrial plants that produce CO₂ as a byproduct.

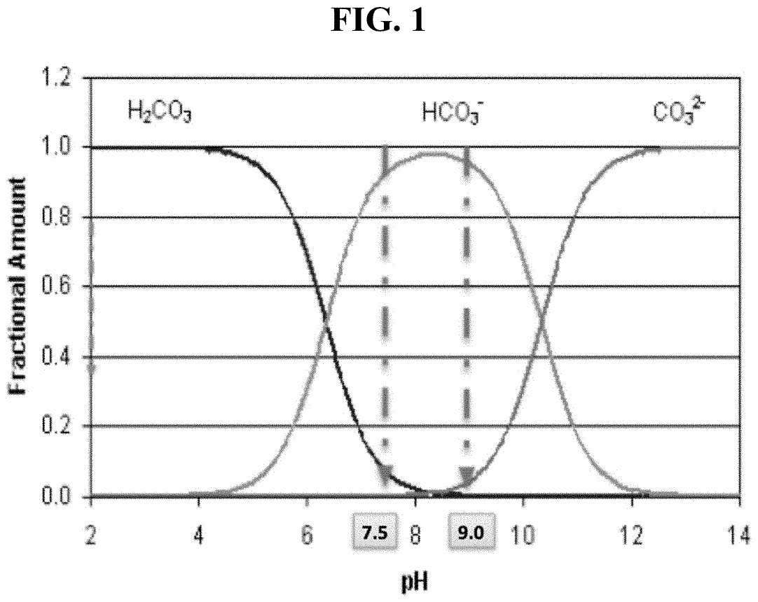

As shown in FIG. 1, if the water solution in which carbon dioxide is sequestered is maintained in a pH range of 7.5 to 9.0 (a pH range which is typical of drinking water distributed for potable use), then the entire amount of the injected carbon dioxide can be expected to remain completely dissolved and remain in the water in a soluble form indefinitely (note in FIG. 1 the HCO₃⁻ concentration being near 100% in the pH range of 7.5-9.0). This sequestration process allows the CO₂ to be permanently removed from the atmosphere and no longer act as greenhouse effect-creating gas.

As also shown in the FIG. 2 embodiment, a source of alkaline chemicals 40 may be provided to more precisely control the pH of the effluent water 50 released from the engineered mixing reactor 30. The control of the pH of the water containing the now-sequestered carbon dioxide also provides the benefit of minimizing corrosion of downstream piping and storage facilities.

A source of high calcium content water may be generated in an industrial process, such as a desalination process as disclosed in U.S. patent application Ser. No. 16/371,816, the disclosure of which is incorporated herein by reference. In such a process, a discharge (“reject”) stream from a separation unit (for example, from the shell side of a hollow fine fiber forward osmosis unit) typically has a very high concentration of divalent minerals such as calcium and magnesium, at concentration levels up to more than five times their concentration of the incoming source seawater or brackish water.

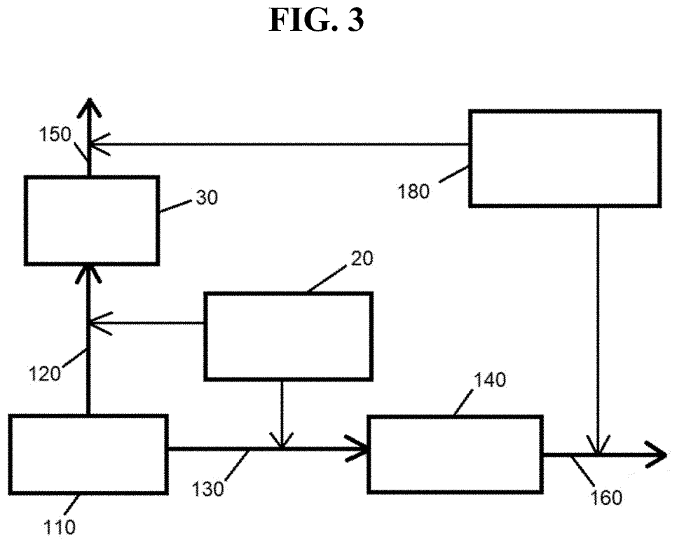

In an alternative embodiment, instead of a high calcium concentration source water 10 being input into the FIG. 2 engineered reactor, as shown in FIG. 3 a source water of low calcium content may be input, with bicarbonate formation being caused in the engineered reactor 30 by contact of the CO₂-containing source water with a solid calcium source, such as calcite.

Desalination refers to any of several processes that remove excess salt and other minerals from water. In desalination, water is desalinated in order to be converted to fresh water suitable for animal consumption or irrigation, or, if almost all of the salt is removed, for human consumption. Desalination methods of interest include, but are not limited to: distillation methods, e.g., multi-stage flash distillation (MSF), multiple-effect evaporator (MED/ME), vapor-compression evaporation (VC) and evaporation/condensation; ion exchange methods; and membrane processes (electrodialysis reversal (EDR), reverse osmosis (RO), nanofiltration (NF), forward osmosis (FO), membrane distillation (MD), etc.).

FIG. 3 schematically illustrates a system associated with a desalination facility that may use to advantage multiple discharge streams from a desalination plant to sequester CO₂. In this embodiment, a desalination plant 110, such as a desalination plant disclosed in U.S. application Ser. No. 16/371,816 (incorporated by reference herein), produces at least two discharge streams, including a desalinated water stream having low calcium content 120 and a concentrated brine stream having a high calcium content 130 (such as a nanofiltration retentate discharge stream as in U.S. application Ser. No. 16/371,816) or desalination brine. Both the low-calcium desalinated water stream and the high-calcium concentrated brine stream receive carbon dioxide from a CO₂ gaseous stream source 20. The low-calcium desalinated water stream is fed to an engineered reactor 30 where bicarbonate is formed by contact of the CO₂-containing desalinated water with a solid calcium source. The concentrated brine is fed to another engineered reactor 140 where bicarbonate is formed by chemical reaction of the carbon dioxide with calcium hydroxide, calcium sulfate or calcium carbonate contained in the brine. Following the chemical reactions in the engineered reactors, the output water streams 150, 160 may have their respective pH levels adjusted by alkaline chemical source 170 before being sent downstream to a fresh water distribution system, a storage facility (for example, a basin or a tank), or otherwise utilized (for example, as a clean water source in another industrial process).

The present invention is not limited to CO₂ injection between discharge from a concentration unit and before entry into an engineered reactor. Rather, the carbon dioxide addition step is performed, whether before and/or after desalination processing, as long as the water is subjected to conditions needed for near 100% conversion of carbon dioxide to calcium bicarbonate (“calcium bicarbonate generation conditions”).

Further, contact of the water with the source CO₂ may occur before and/or during the time when the water is subject to calcium bicarbonate formation conditions, for example, injected in the engineering reactor instead of or in addition to injection of the CO₂ upstream of the engineered reactor, i.e., the water is contacted with a source of CO₂ while the volume of water is being subjected to calcium bicarbonate formation conditions.

The potential CO₂ sources include waste gas streams (or analogous streams) that are produced as a byproduct of an active process of the industrial plant or side product from desalination of saline water by thermal evaporation. The gaseous stream may be substantially pure CO₂ or a multi-component gaseous stream that includes CO₂ and one or more additional gases. Such streams may include both reducing condition streams such as syngas, shifted syngas, natural gas, gas released from thermal desalination, and hydrogen and the like, and oxidizing condition streams such as flue gases from combustion. In particular, such multi-component gaseous streams of interest include oxygen containing combustion power plant flue gas, turbocharged boiler product gas, coal gasification product gas, shifted coal gasification product gas, anaerobic digester product gas, wellhead natural gas stream, reformed natural gas or methane hydrates, and the like. In some embodiments the CO₂ source may be flue gas from coal or other fuel combustion, which is contacted with the volume of source water with little or no pretreatment of the flue gas. In these embodiments, the calcium ions in the water react with the source of calcium such as calcium carbonate to form calcium bicarbonate.

In certain embodiments, a desulfurization step may be staged to coincide with the calcium carbonate formation step, or may be staged to occur before this step. In certain embodiments therefore may be multiple sets of reaction products collected at different stages, while in other embodiments there is a single reaction product collected.

The volume of water may be contacted with the CO₂ source using any convenient protocol. Where the CO2 is a gas, contact protocols of interest include, but are not limited to: direct contacting protocols such as bubbling the gas through the volume of source water, concurrent contacting (i.e., contact between uni-directionally flowing gaseous and liquid phase streams), countercurrent contacting (i.e., contact between oppositely flowing gaseous and liquid phase streams), and the like. Thus, contact may be accomplished through use of infusers, bubblers, a fluidic Venturi reactor, a sparger, a nozzle or a system of nozzles, filter plate, a gas filter, spray, a tray, a packed column reactors, and the like.

If carbon dioxide-sequestering water is to be discharged to the environment, pH adjustment may be needed to meet may be necessary environmental regulatory requirements. This is because typically the pH of the concentrate/brine produced by desalination plants is of lower pH than the ambient source seawater or brackish water, or of fresh surface water, and therefore often the pH of the concentrate discharge needs to be adjusted, such that the increased pH of the concentrate will be in the same range as that of the pH of the water body receiving the concentrate.

The present invention also is not limited to fixed land-based facilities, but may be used in other applications, such as with a desalination system on a ship, which typically takes aboard sea water via an inlet port in the hull of the ship or desalination plant located on oil rigs/platforms to produce water for the rig operation.

The foregoing disclosure has been set forth merely to illustrate the invention and is not intended to be limiting. Because such modifications of the disclosed embodiments incorporating the spirit and substance of the invention may occur to persons skilled in the art, the invention should be construed to include everything within the scope of the appended claims and equivalents thereof.

### LISTING OF REFERENCE LABELS

10 source water stream
20 CO₂ gas stream source
30 engineered reactor containing calcium source
40 alkaline chemical source
50 effluent water
60 degasifier
7 chlorine gas
8 NaOH
9 potable water
110 desalination plant
120 desalinated water of low calcium content
130 brine of high calcium content
140 engineered brine —CO₂ mixing reactor
150 low salinity output stream with sequestered CO₂.
160. high salinity output stream with sequestered CO₂
170 Alkaline Chemical for pH adjustment

What is claimed is:

1. A method of sequestering carbon, comprising the acts of:
providing a source of carbon dioxide in gaseous or dissolved form;
introducing the carbon dioxide into calcium-containing source water;
mixing the carbon dioxide in the calcium-containing source water in an engineered reactor in the presence of calcium hydroxide or calcium carbonate such that the carbon dioxide is converted into dissolved calcium bicarbonate; and
discharging the dissolved calcium bicarbonate-containing source water to a natural surface water body having a pH 7.5-9.0, or to a man-made facility for storage or further use.

2. The carbon sequestration method of claim 1, wherein
the pH of the discharged calcium bicarbonate-containing water is adjusted to pH 7.5-9.0 before the act of discharging.

3. The carbon sequestration method of claim 1, wherein
the calcium-containing source water is a retentate discharge or brine discharge from a desalination process or wastewater reclamation process, and
the calcium-containing source water has a calcium concentration higher than a calcium concentration of a feed water to the desalination process.

4. The carbon sequestration method of claim 1, wherein
the calcium-containing source water is brackish water, seawater; cooling water from an electric power generation plant, treated or untreated wastewater, reclaimed water or a combination thereof.

5. The carbon sequestration method of claim 1, wherein
the natural surface water body has a pH in a range of 7.5-9.0, and
the natural surface water body is an ocean, a bay, an estuary, a river, a lake or a ground water.

6. The carbon sequestration method of claim 1, wherein
the source of the carbon dioxide is internal combustion engine exhaust, gas generated by degasification from thermal desalination, burning of fossil fuel, ethanol production, food and beverage production, pharmaceutical production, chemical production, natural carbon dioxide emissions, or a combination thereof.

7. A method of sequestering carbon, comprising the acts of:
providing a source of carbon dioxide in gaseous or dissolved form;
contacting the carbon dioxide in the calcium-containing source water with a solid calcium source in an engineered reactor such that the carbon dioxide is converted into dissolved and chemically bound calcium bicarbonate; and
discharging the dissolved calcium bicarbonate-containing source water to a natural surface water body having a pH 7.5-9.0, or to a man-made facility for storage or further use.

8. The carbon sequestration method of claim 7, wherein
the pH of the discharged calcium bicarbonate-containing water is adjusted to pH 7.5-9.0 before the act of discharging.

9. The carbon sequestration method of claim 7, wherein
the calcium-containing source water is a permeate produced by membrane desalination process including membrane wastewater treatment process, a distillate produced by thermal desalination process, or a combination thereof

10. The carbon sequestration method of claim 7, wherein
the calcium-containing source water is desalinated water, treated wastewater, untreated wastewater or reclaimed wastewater.

11. The carbon sequestration method of claim 7, wherein
the natural surface water body has a pH in a range of 7.5-9.0, and
the natural surface water body is an ocean, a bay, an estuary, a river, a lake or a ground water.

12. The carbon sequestration method of claim 7, wherein
the solid calcium source is calcite, dolomite, calcium hydroxide, calcium sulfate, calcium hypochlorite or a combination thereof.

13. The carbon sequestration method of claim 7, wherein
the further use includes use in applications in which pH is maintained in a range of 7.5-9.0, the applications including drinking water, irrigation water, power plant cooling water, industrial water, horticultural water or municipal water or wastewater.

14. The carbon sequestration method of claim 1, wherein
the source of the carbon dioxide is internal combustion engine exhaust, gas generated by thermal desalination of saline water, burning of fossil fuel, ethanol production, food and beverage production, pharmaceutical production, chemical production, natural carbon dioxide emissions, or a combination thereof.
